(19) United States
(12) Patent Application Publication
(10) Pub. No.: US 2020/0118152 A1
(43) Pub. Date: Apr. 16, 2020

(54) LINKING USER FEEDBACK TO TELEMETRY DATA

(71) Applicant: Hewlett-Packard Development Company, L.P., Spring, TX (US)

(72) Inventor: John Landry, Houston, TX (US)

(73) Assignee: Hewlett-Packard Development Company, L.P., Spring, TX (US)

(21) Appl. No.: 16/603,860

(22) PCT Filed: Apr. 14, 2017
(86) PCT No.: PCT/US2017/027786

§ 371 Date: Oct. 9, 2019

(51) Int. Cl. G06Q 30/02; G06N 20/00

(52) U.S. Cl. CPC G06Q 30/0217; G06N 20/00

(57) ABSTRACT

Linking user feedback to telemetry data includes collecting, in a computer system, telemetry data from at least one electronic device. Survey data is collected related to user feedback associated with the at least one electronic device. Data patterns are correlated in the telemetry data with data patterns in the survey data. The survey data is linked with the telemetry data based on the correlated data patterns to contextualize the user feedback to the telemetry data.

### BACKGROUND

Manufacturers and providers of products and services often solicit customer feedback to gather information and customer experience pertaining to the product or service. Customer feedback may lack context, which may lead to misinterpretation of the feedback. For example, if the user reports a problem while providing the feedback, it may be difficult to determine the root cause of an identified problem because the actual problem may have occurred several weeks or months prior to providing the feedback.

### BRIEF DESCRIPTION OF THE DRAWINGS

FIG. 1A is a block diagram of a computer system receiving telemetry and survey data, according to a first example herein;

FIG. 1B is a block diagram of a computer system receiving telemetry and survey data, according to a second example herein;

FIG. 1C is a block diagram of a computer system receiving telemetry and survey data, according to a third example herein;

FIG. 1D is a block diagram of a computer system receiving telemetry and survey data, according to a fourth example herein;

FIG. 1E is a block diagram of a computer system receiving telemetry and survey data, according to a fifth example herein;

FIG. 2A is a flowchart illustrating a method, according to an example herein;

FIG. 2B is a flowchart illustrating a method, according to another example herein;

FIG. 3 is a block diagram illustrating computer architecture, according to an example herein; and

FIG. 4 is a flowchart illustrating a software code of instructions, according to an example herein.

### DETAILED DESCRIPTION

A user of an electronic device such as a printer, laptop, etc. may be asked to provide feedback of the product to better identify potential technical issues and to gauge user experience. The feedback is provided in the form of surveys. Surveys may be based on how long the customer has owned the product, used the service, or the surveys are randomly presented to the customer. The examples described herein are directed to linking a user's feedback of a product or service with the telemetry data associated with the product or service. The telemetry data is automatically collected from the device associated with the product or service. Linking the feedback with the telemetry data offers an opportunity to ensure that any problems with the product or service identified by the user may be efficiently analyzed to determine root causes, and also any problems identified by the telemetry data may be further analyzed once a user provides feedback. This results in offering valuable context as to how well the product or service is functioning at the actual time of the survey.

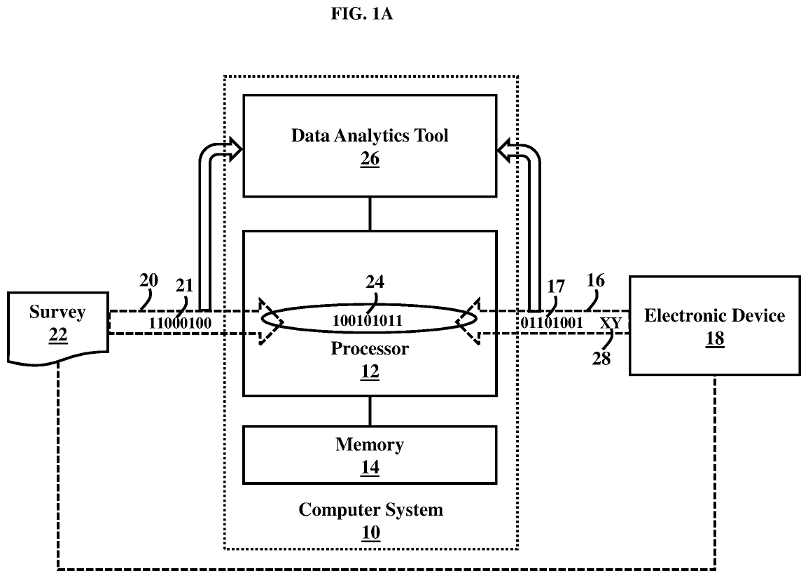

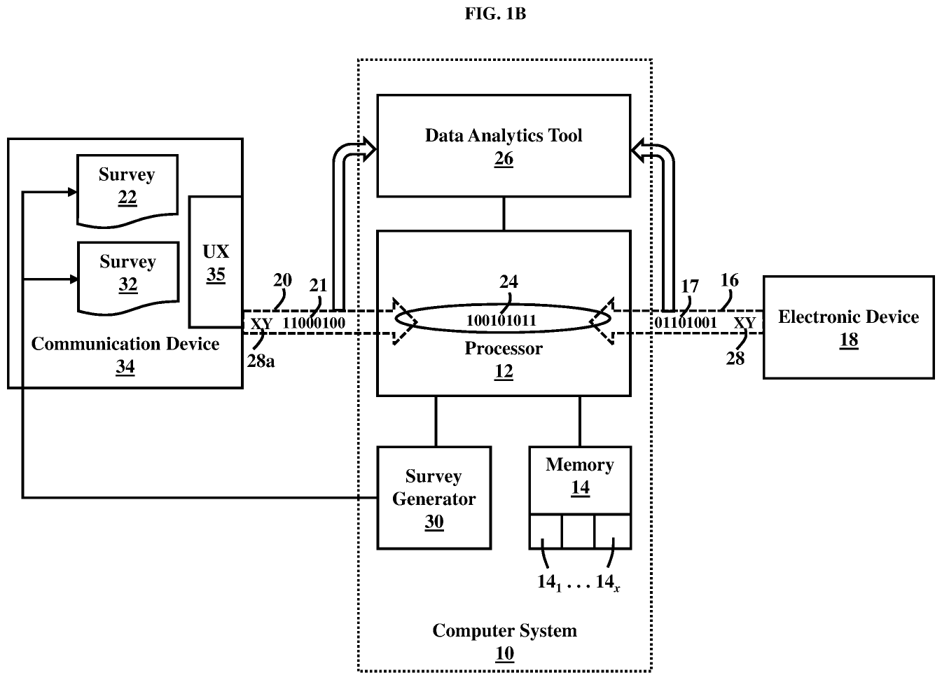

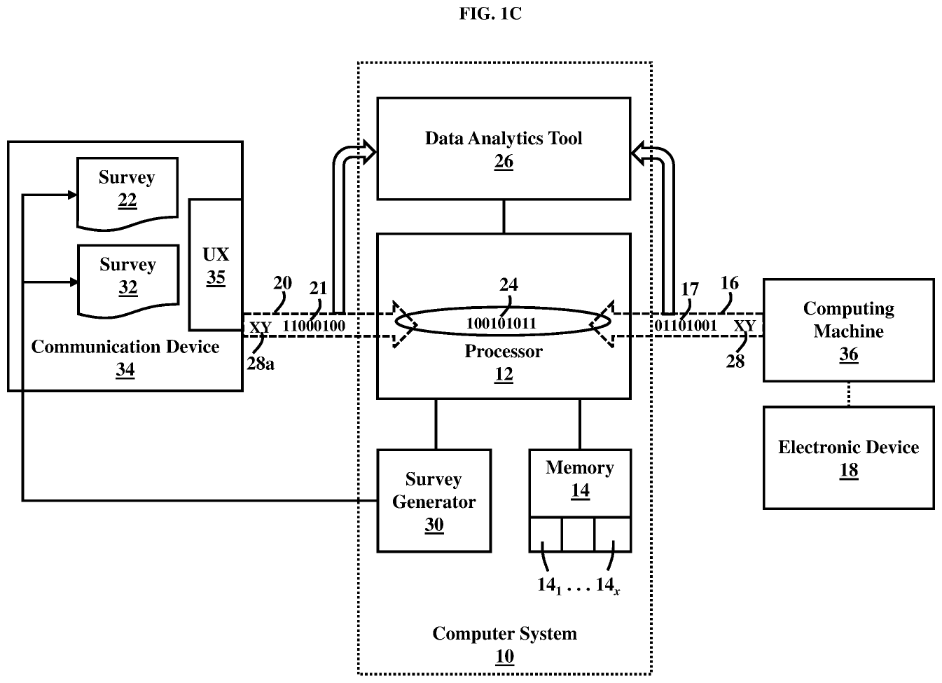

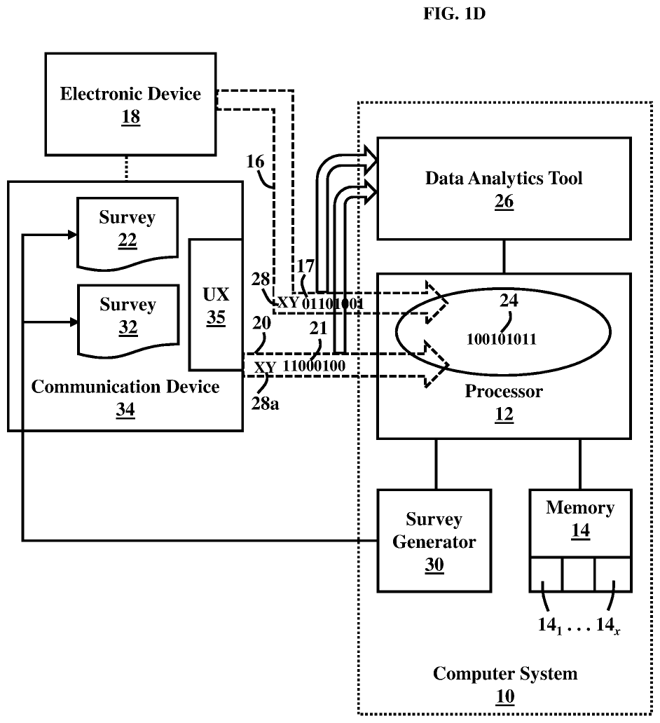

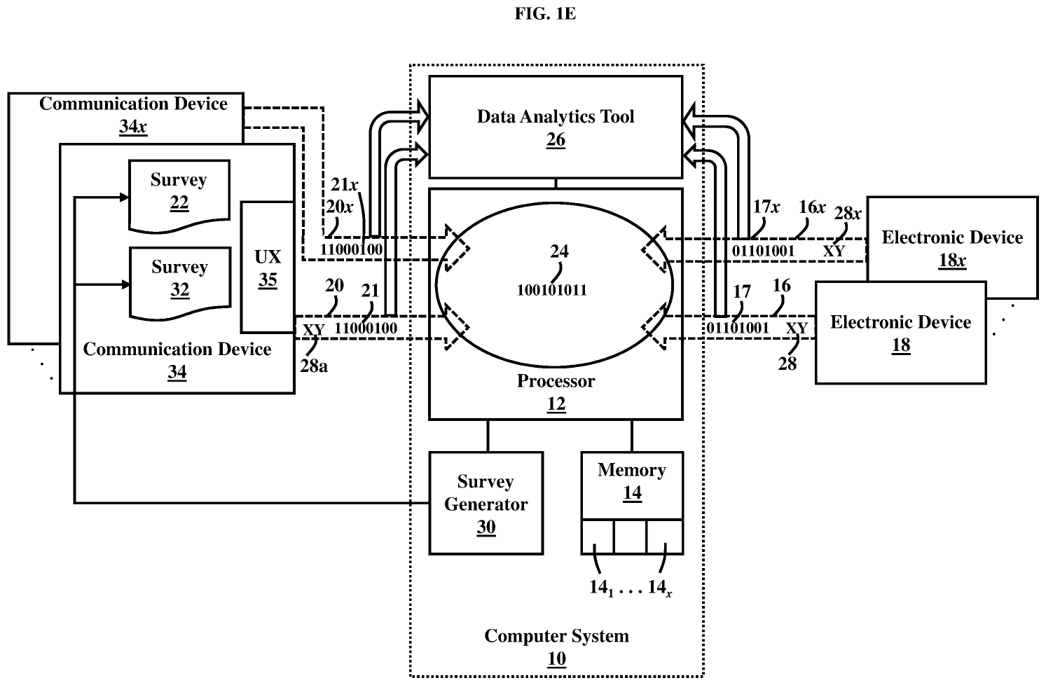

FIG. 1A illustrates a block diagram of a computer system 10 comprising a processor 12 and a memory 14 comprising instructions executable by the processor 12 to analyze telemetry data 16 associated with an electronic device 18, analyze survey data 20 from a first survey 22 related to user feedback associated with the electronic device 18, identify data patterns 17, 21 in the telemetry data 16 and the survey data 22, respectively, and link the survey data 22 with the telemetry data 16 based on correlated data patterns 24 between the telemetry data 16 and the survey data 22. A data analytics tool 26 mines the telemetry data 16 for the data patterns 17 associated with any of known attributes and anomaly attributes of the electronic device 18. The telemetry data comprises an identification code 28, and the instructions executable by the processor 12 link the survey data 22 with the telemetry data 16 based on the identification code 28.

FIG. 1B, with reference to FIG. 1A, illustrates another block diagram of the computer system 10 comprising processor 12 and memory 14 comprising instructions executable by the processor 12 to analyze telemetry data 16 associated with the electronic device 18. In the context of the examples herein, the electronic device 18 may be a product, service, electronic, or other type of device that has the ability to create, log, store, categorize, or transmit data associated with the use, operation, or state of the device. The computer system 10 may be configured as a server, cloud-based service, or any type of data processing system according to the examples herein. A user may be asked to provide feedback to a manufacturer or provider of the electronic device 18, or to a third-party data collector or analyzer associated with the electronic device 18. The feedback is driven by one or more surveys 22, 32, which the user completes. The surveys 22, 32 may be conducted on a communication device 34 set to display the surveys 22, 32 and to interface with the user, allow a user to respond to the surveys 22, 32, and transmit the surveys 22, 32 to the computer system 10. The communication device 34 may be configured as a display device, such as a computer screen, smartphone, or tablet computer and may include a user interface (UX) 35 as a mechanism to interface the surveys 22, 32 with the user. The surveys 22, 32 may also be presented on a webpage or through email, or other form of electronic communication or service. The surveys 22, 32 may also be provided in a software application or downloadable app running on the electronic device 18 or the communication device 34. The user may or may not be affiliated with the manufacturer or provider of the electronic device 18. For example, the user may be a customer, client, end-product user, or alternatively may be an employee of the manufacturer or provider of the electronic device 18, who may be providing feedback to the internal constituents of the manufacturer or provider of the electronic device 18 such an information technology (IT) administrator, etc.

The UX 35 may provide a series of guided questions as a way of presenting the surveys 22, 32 for which the user provides answers. The surveys 22, 32 may be configured as NetPromoter® Score (NPS®) surveys, available from Satmetrix Systems, Inc., San Mateo, Calif., or other type of customer loyalty metric survey. One of the challenges in getting meaningful information in surveys is the user's perceived nuisance in completing a series of questions requiring a significant time commitment. Sometimes users will simply forego completing a survey even if there is a problem with a device that is the subject of the survey, which the user wishes to report, due to this perceived time commitment. Accordingly, in one example, the surveys 22, 32 may comprise a single question survey. This aids in encouraging users to participate and complete the surveys 22, 32 as the time to complete the survey is relatively low, and the subject of the surveys 22, 32 are directed and specific to only one or just a few issues.

The processor 12, which may be configured as a microprocessor as part of the computer system 10, analyzes the survey data 20 from a first survey 22 related to user feedback associated with the electronic device 18. The processor 12 may further be configured as an application-specific integrated circuit (ASIC) processor, a digital signal processor, a networking processor, a multi-core processor, or other suitable processor selected to be communicatively linked to the electronic device 18 and the communication device 34. In the context of the examples herein, the first survey 22 refers to the initial survey conducted in a sequence of receiving feedback from a user with respect to the electronic device 18. A second survey 32 refers to a subsequent survey being conducted after the first survey 22. However, the first survey 22 could also refer to a subsequent survey conducted by the same or different user with respect to the same or different electronic device 18 such that if the first survey 22 relates to the same electronic device 18, then the first survey 22 may relate to a different topic than previously presented. Accordingly, as used herein first survey 22 and second survey 32 only refer to the sequence of surveys relative to one another, and not necessarily in relation to any other surveys conducted in the past or in the future with respect to the electronic device 18. In other words, the first survey 22 is used to describe a survey that occurs before the second survey 22, such that the second survey 22 may be based, in part, on the feedback provided in the first survey 22.

Occurring in parallel to the survey process, telemetry data 16 associated with the electronic device 18 is constantly being generated by the electronic device 18 and transmitted to the processor 12 and a data analytics tool 26. The telemetry data 16 may include anything relating to the electronic device 18 including its instrumentation, connected peripheries, mechanical components, electrical components, state of operation, usage, maintenance, software, hardware, firmware, as well as other types of characteristics. The telemetry data 16 may be categorized by the electronic device 18 itself or a communicatively coupled device such as computing machine 36, and the categorization may be any of event-based, time-based, failure-based, or any other categories of operation of the electronic device 18. In one example, the electronic device 18 contains a data collection agent application running consistently and gathering all events, in the form of the telemetry data 16, from the electronic device 18 thereby providing a complete history of the operation of the electronic device 18 from the moment it is first set-up and used by the customer. The telemetry data 16 is then logged on the electronic device 18 or may be transmitted to the processor 12 and logged and stored in the memory 14, or it may reside in the data analytics tool 26, and could be stored in a cloud-based environment or service.

The telemetry data 16 may be automatically generated and transmitted to the processor 12 and the data analytics tool 26 or it may be logged and transmitted once prompted by an application run by the electronic device 18 or run on a separate computing machine 36 communicatively coupled to the electronic device 18. For example, if the electronic device 18 is a printer, then the telemetry data 16 could be sent from the printer to the computing machine 36, which may be a computer, tablet, or smart phone and consolidated by a software application or app running on the computing machine 36, which then transmits the telemetry data 16 to the processor 12 and the data analytics tools 26, as illustrated in FIG. 1C. In another example, shown in FIG. 1D, the electronic device 18 may be communicatively coupled to the communication device 34, or the electronic device 18 and the communication device 34 may constitute the same device such as both the telemetry data 16 and the survey data 20 originate from the same source; e.g., a combined electronic device 18 and communication device 34. For example, if the electronic device 18 is a laptop computer, then the surveys 22, 32 may be provided on the laptop and once completed by the user, the survey data 20 along with the telemetry data 16 of the laptop are transmitted to the processor 12 or data analytics tool 26.

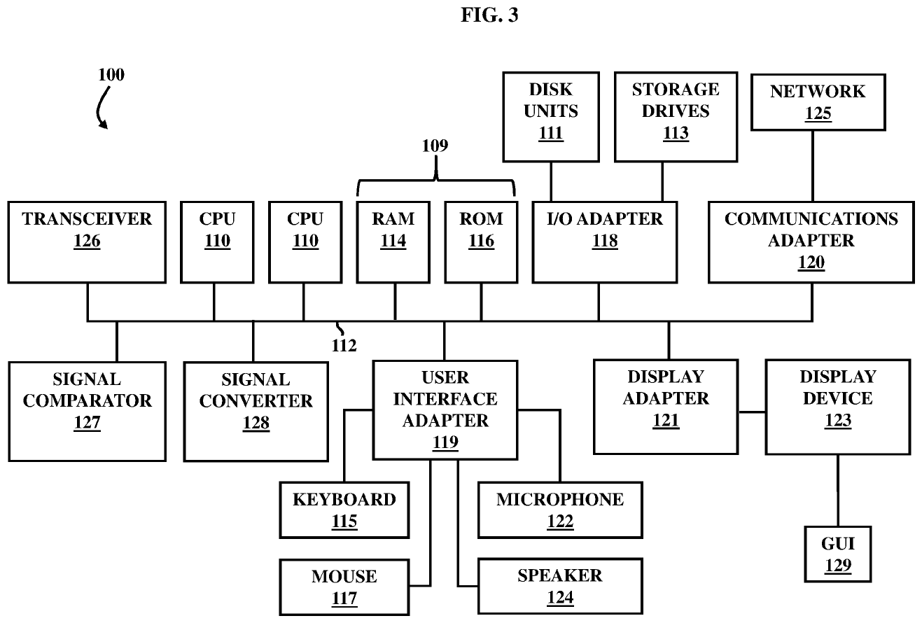

Both the telemetry data 16 and the survey data 20 may be locally saved on the electronic device 18, communication device 34, or computing machine 36, as appropriate. Alternatively, the telemetry data 16 and the survey data 20 are not locally saved, but rather are saved in memory 14 of the computer system 10 or some other data storage repository. Additionally, both the telemetry data 16 and the survey data 20 may be transmitted to the processor 12 or data analytics tool 26 through wireless or wired communication over a network, such as the network 125 further described with reference to FIG. 3 below. Such transmission of the telemetry data 16 and the survey data 20 may occur over either secured or unsecured channels.

The processor 12 identifies data patterns 17, 21 in the telemetry data 16 and the survey data 20, respectively, and then the processor 12 links the survey data 20 with the telemetry data 16 based on correlated data patterns 24 between the telemetry data 16 and the survey data 20. In an example, the data patterns 17, 21 may include collections of digital bits arranged in binary code or other coding units, which the processor 12 parses, clusters, and statistically analyzes to group similarly arranged code in order to identify the patterns 17, 21. In another example, the data analytics tool 26 substitutes for, or is used in conjunction with, the processor 12 to perform the identification of the data patterns 17, 21 in order to generate the correlated data patterns 24.

As mentioned, the telemetry data 16 may be constantly generated. However, in one example, at the point the user submits the survey 22, which could occur through the UX 35 and transmitted to the computer system 10, the processor 12 or data analytics tool 26 isolates and analyzes the telemetry data 16 which is being simultaneously sent to the computer system 10 from the electronic device 18 to provide context of the user feedback to a particular time, state of operation, or mode of operation of the electronic device 18. This allows the processor 12 or data analytics tool 26 to associate the survey data 20 with the telemetry data over a fixed period of time, such that the data patterns 17, 21 are analyzed over this same fixed period of time in order to create the correlated data patterns 24. Alternatively, the processor 12 may analyze a complete historical record of the telemetry data 16 of the electronic device 18 up to the time that the survey 22 is submitted to the computer system 10. However, even after this point the electronic device 18 continues to generate telemetry data 16.

The telemetry data 16 and the survey data 20 may be aggregated using a feedback event identification code. In this regard, in one example the telemetry data 16 may comprise an identification code 28, wherein the instructions executable by the processor 12 may link the survey data 20 with the telemetry data 16 based on the identification code 28. In another example, the survey data may also comprise a complimentary identification code 28a such that the identification code 28 in the telemetry data 16 correlates with the identification code 28a in the survey data 20, and the processor 10 uses the correlated identification codes 28, 28a to (i) create the correlated data patterns 24, and (ii) provide context to the user feedback with an identifiable event occurring in the electronic device 18 by way of the telemetry data 16. The identification codes 28, 28a may be configured as binary digits, quantum bits, or other coding units in the telemetry data 16 and survey data 20, respectively. In another example, the user feedback in the form of the survey data 20 is classified by the processor 10 based on a feedback topic of the survey 22, which may be directly provided by the user through the UX 35 or harvested from text provided by the user.

As shown in FIG. 1E, the data analytics tool 26 may be set to compare the telemetry data 16, . . . 16x and the survey data 20, . . . 20x across multiple electronic devices 18, . . . 18x and from multiple user feedback received from multiple communication devices 34, . . . 34x. The telemetry data 16, . . . , 16x are unique to each specific electronic device 18, . . . 18x, but the corresponding data patterns 17, . . . 17x may be similar to or different from one another. Likewise, the survey data 20, . . . 20x are unique to each user and come from each specific communication device 34, . . . 34x, but the corresponding data patterns 21, . . . 21x may be similar to or different from one another. The telemetry data 16, . . . , 16x may comprise an identification code 28, . . . 28x, wherein the instructions executable by the processor 12 may link the survey data 20, . . . 20x with the telemetry data 16, . . . , 16x based on the identification code 28, . . . 28x.

The data analytics tool 26, which may be cloud-based, may provide sentiment analysis of the survey 22 and may also conduct data or opinion mining of the telemetry data 16 for the data patterns 17 associated with any of known attributes and anomaly attributes of the electronic device 18, which is further described below. The sentiment analysis of the surveys 22, 32 helps identify, with greater particularity, the true expression, opinion, and reasoning of the user in providing the feedback. The surveys 22, 32 may be properly crafted to directly gauge a user's sentiment of a particular topic, and may include images such as emojis to reflect the user's true sentiment. The data analytics tool 26 may be part of the computer system 10 or may be separately configured, or the data analytics tool 26 may be part of the processor 12 or it may be communicatively coupled with the processor 12. A survey generator 30 may generate the first survey 22 for user feedback based on any of the telemetry data 16 and the data patterns 17. The survey generator 30 may generate a second survey 32 for user feedback based on any of the telemetry data 16, survey data 20, and the data patterns 17, 21, 24. The survey generator 30 may or may not be part of the computer system 10 and could be provided by a third party source. In one example, the survey generator may be a software application resident on the electronic device 18, communication device 34, or computing machine 36. The second survey 32 permits a way to contact the user/customer after the first survey 22 is conducted in order to determine the exact scope of the problem, troubleshoot the problem, follow-up on the results of a solution provided to the user/customer, or for any reason. The results of the second survey 32 is transmitted similarly as with the first survey 22; i.e., using survey data 20, and is analyzed in accordance with the telemetry data 16 in the manners described above. The surveys 22, 32 may be generated autonomously from any direction by the user. For example, the survey generator 30 may generate the surveys 22, 32 according to a predetermined time guide, such as X number of days following installation or set up of the electronic device 18. Moreover, the surveys 22, 32 may be generated based on a specific correlated data pattern 24 identified by the processor 12 or data analytics tool 26. Furthermore, the surveys 22, 32 may be generated based on feedback from other users or other electronic devices 18, . . . 18x, as well as the corresponding telemetry data 16, . . . 16x or survey data 20, . . . 20x in the population of users. Alternatively, the survey generator 30 may generate the surveys 22, 32 based on user input. For example, a user may elect to submit a survey 22, 32 at any time and for any reason.

In an example implementation, a user may provide negative feedback about a function of the electronic device 18 describing the symptoms and impact to the usage of the electronic device 18. The telemetry data 16 is mined by the processor 12 or data analytics tool 26 for known patterns 17 relating to the symptoms and for new outliers of problems. The results are compared to other customer feedback for similar devices 18, . . . 18x and to the telemetry data 16, . . . 16x for the overall data population to further train the machine learning techniques of the computer system 10. The insights from the analysis may be used to improve the devices 18, . . . 18x and they may be used to provide solutions back to the user/customer.

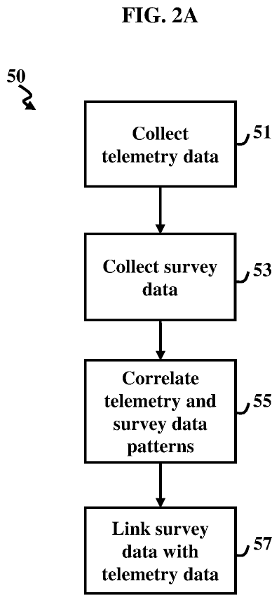

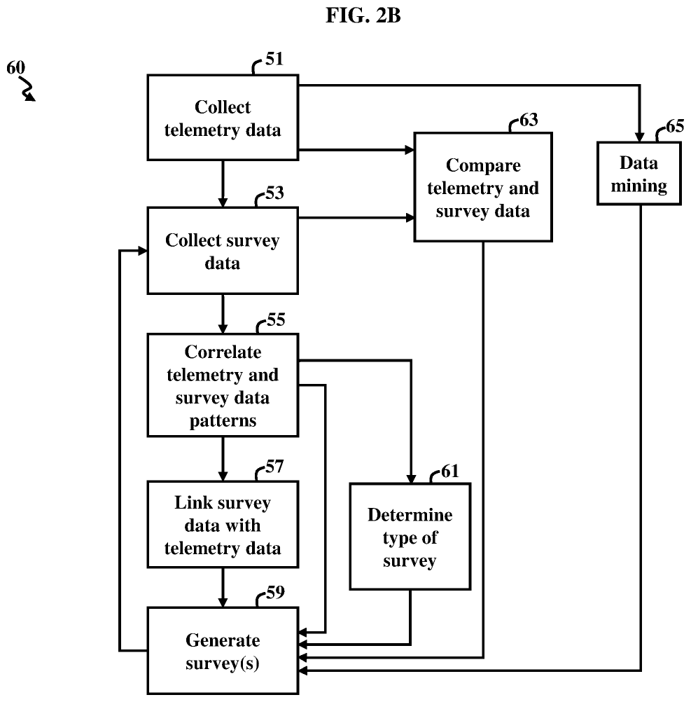

FIG. 2A, with reference to FIGS. 1A through 1E, is a flowchart illustrating a method 50, according to an example. Block 51 describes collecting, in a computer system 10, telemetry data 16 from at least one electronic device 18. Block 53 provides collecting, in the computer system 10, survey data 20 related to user feedback associated with the at least one electronic device 18. In one example, the telemetry data 16 may be collected up to a time of collecting the survey data 20. In block 55 the data patterns 17 in the telemetry data 16 are correlated, in the computer system 10, with data patterns 21 in the survey data 20 to create correlated data patterns 24. Block 57 shows the survey data 20 being linked, in the computer system 10, with the telemetry data 16 based on the correlated data patterns 24 to contextualize the user feedback to the telemetry data 16. In an example, the telemetry data 16 may comprise an identification code 28, wherein the survey data 20 may be linked with the telemetry data 16 based on the identification code 28. In another example, the survey data 20 may also comprise an identification code 28a that relates to the identification code 28 of the telemetry data 16 to further allow for the correlated data patterns 24 to be identified.

FIG. 2B, with reference to FIGS. 1A through 2A, is a flowchart illustrating a method 60, according to another example. The method 60 includes steps 51-57 of method 50 shown in FIG. 2A, and further comprises generating a survey 22, 32 for user feedback based on any of the telemetry data 16 and the data patterns 17, 21, 22 as indicated in block 59. The survey 22, 32 may be generated at a specified time based on the telemetry data 16. Block 61 describes determining the type of survey to generate based on any of the telemetry data 16 and the data patterns 17, 21, 22. For example, a specific type of survey may be more suitable in certain circumstances, such as surveys that ask for ratings, or comparisons, or ones that request a user to provide free text to fully explain an answer to a survey question. Block 63 indicates that the telemetry data 16 and the survey data 20 are compared across multiple electronic devices 18, . . . 18x and from multiple user feedback.

The telemetry data 16 may be mined for the data patterns 17 associated with any of known attributes and anomaly attributes of the at least one electronic device 18, as provided in block 65. In one example, the telemetry data 16 may be mined in real-time as the telemetry data 16 is collected. The computer system 10 may use intelligence provided by the telemetry data 16 to determine when to collect specific user feedback based upon the output of a machine learning algorithm run by the processor 12 that monitors the telemetry data 16. In this regard, telemetry data 16, . . . 16x is collected continuously from a population of users of devices, services, or applications; e.g., electronic devices 18, . . . 18x. The algorithm identifies outliers and anomalies in the data patterns 17, . . . 17x. When a particular pattern is discovered, it is desired to also know the effect the anomaly may have on one or more users. At this point an anomaly specific survey; e.g., a second survey 32, could be targeted at the population of devices, services, or applications 18, . . . 18x reporting the same anomaly. The response to the survey 32 is linked backed to the anomaly through an anomaly identification code 28, . . . 28x. With the feedback from the user, a customer impact value may immediately be placed on the anomaly driving the priority of action.

In an example implementation, a machine learning algorithm run by the processor 12 detects an anomaly of the battery degradation on a particular laptop model. The manufacturer or provider of the laptop may need to determine the impact of this battery degradation on the users of the same laptop model. A survey 22 is triggered on the laptop. The user provides feedback of their score of the battery performance along with other comments. The survey data 20 is collected for the targeted population of users immediately providing user context to the anomaly. Based on the context, the action to take as well as the priority may easily be determined. In this example, the user population of users could be offered a new battery with the cost covered by the battery supplier, etc.

A representative hardware environment for practicing the examples herein is depicted in FIG. 3, with reference to FIGS. 1A through 2. This block diagram illustrates a hardware configuration of an information handling/computer system 100 according to an example herein. The system 100 comprises one or more processors or central processing units (CPU) 110, which may communicate with processor 12, or in an alternative example, the CPU may be configured as processor 12. For example, FIG. 3 illustrates two CPUs 110. The CPUs 110 are interconnected via system bus 112 to at least one memory device 109 such as a RAM 114 and a ROM 116. In one example, the at least one memory device 109 may be configured as the memory device 14 or one of the memory elements 14₁, . . . , 14ₓ of the memory device 14. The at least one memory device 109 may include local memory employed during actual execution of the program code, bulk storage, and cache memories which provide temporary storage of at least some program code in order to reduce the number of times code must be retrieved from bulk storage during execution.

An I/O adapter 118 may connect to peripheral devices, such as disk units 111 and storage drives 113, or other program storage devices that are readable by the system 100. The system 100 may include a user interface adapter 119 that may connect the bus 112 to a keyboard 115, mouse 117, speaker 124, microphone 122, and/or other user interface devices such as a touch screen device to gather user input. Additionally, a communication adapter 120 connects the bus 112 to a data processing network 125, and a display adapter 121 connects the bus 112 to a display device 123, which may provide a graphical user interface (GUI) 129 for a user to interact with. Further, a transceiver 126, a signal comparator 127, and a signal converter 128 may be connected to the bus 112 for processing, transmission, receipt, comparison, and conversion of electric or electronic signals, respectively.

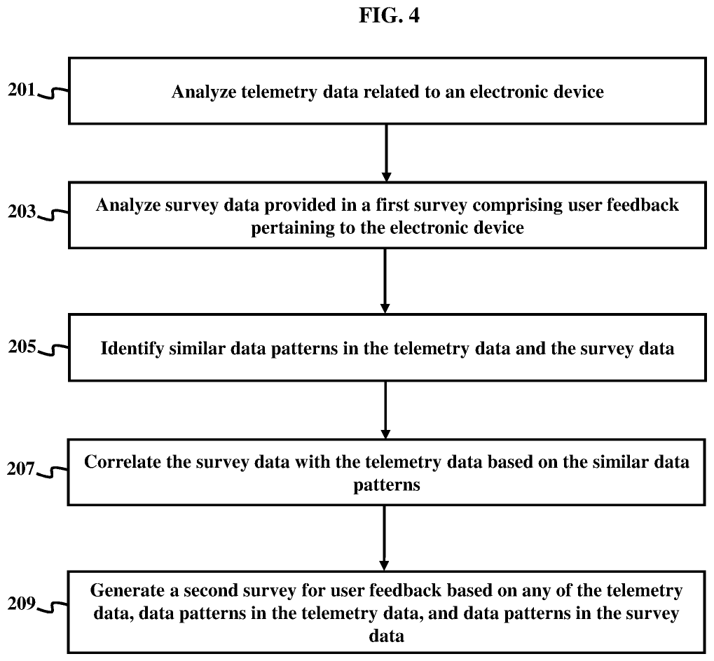

FIG. 4, with reference to FIGS. 1A through 3, illustrates the code of instructions carried out by the information handling/computer system 100. In instruction block 201, the code may be set to analyze telemetry data 16 related to an electronic device 18. In instruction block 203, the code may be set to analyze survey data 20 provided in a first survey 22 comprising user feedback pertaining to the electronic device 18. In an example, the code may be set to compare the telemetry data 16 and the survey data 20 across multiple electronic devices 18, . . . 18x and from multiple user feedback. In instruction block 205, the code may be set to identify similar data patterns 21 in the telemetry data 16 and the survey data 20. In instruction block 207, the code may be set to correlate the survey data 20 with the telemetry data 16 based on the similar data patterns 21. In instruction block 209, the code may be set to generate a second survey 32 for user feedback based on any of the telemetry data 16, data patterns 17 in the telemetry data 16, and data patterns 21 in the survey data 20.

The examples described herein provide techniques to link user/customer feedback data obtained through surveying methods to telemetry data obtained from the product or service being used, or for which an analysis is desired. In one example, a survey 22 is initiated by the user/customer who desires to provide feedback due to a problem they are experiencing with the product or service, such as an electronic device 18, or desiring to provide input on how to improve the product or service. At the time the survey 22 is collected, historical telemetry data 16 is collected up to the time of the survey 22 providing context to the feedback the user is providing. Another example uses machine learning techniques that are monitoring the telemetry data 16 for patterns 17 where survey data 20 from the user may provide valuable data on the user experience correlating to the pattern 24 detected by the machine learning or data analytics techniques. Some of the example methods determine the type of survey to present to the user/customer based on the telemetry data 16. Other example methods collect the telemetry data 16 that is pertinent to the survey 22 provided to the user/customer. The example techniques may target a survey 32 to a specific population based on the telemetry data 16 that is captured. Accordingly, the examples described herein provide techniques for intelligent surveying with contextual data.

The present disclosure has been shown and described with reference to the foregoing exemplary implementations. Although specific examples have been illustrated and described herein it is manifestly intended that the scope of the claimed subject matter be limited only by the following claims and equivalents thereof. It is to be understood, however, that other forms, details, and examples may be made without departing from the spirit and scope of the disclosure that is defined in the following claims.

What is claimed is:

1. A method comprising:
collecting, in a computer system, telemetry data from at least one electronic device;
collecting, in the computer system, survey data related to user feedback associated with the at least one electronic device;
correlating, in the computer system, data patterns in the telemetry data with data patterns in the survey data; and
linking, in the computer system, the survey data with the telemetry data based on the correlated data patterns to contextualize the user feedback to the telemetry data.

2. The method of claim 1, comprising generating a survey for user feedback based on any of the telemetry data and the data patterns.

3. The method of claim 2, comprising determining a type of survey to generate based on any of the telemetry data and the data patterns.

4. The method of claim 1, comprising comparing the telemetry data and the survey data across multiple electronic devices and from multiple user feedback.

5. The method of claim 1, comprising collecting the telemetry data up to a time of collecting the survey data.

6. The method of claim 1, comprising mining the telemetry data for the data patterns associated with any of known attributes and anomaly attributes of the at least one electronic device.

7. The method of claim 1, comprising mining the telemetry data in real-time as the telemetry data is collected.

8. The method of claim 2, wherein the survey comprises a single question survey.

9. The method of claim 1, wherein the telemetry data comprises an identification code, and wherein the method further comprises linking the survey data with the telemetry data based on the identification code.

10. The method of claim 2, comprising generating the survey at a specified time based on the telemetry data.

11. A computer system comprising:
a processor;
a memory comprising instructions executable by the processor to:
analyze telemetry data associated with an electronic device;
analyze survey data from a first survey related to user feedback associated with the electronic device;
identify data patterns in the telemetry data and the survey data; and
link the survey data with the telemetry data based on correlated data patterns between the telemetry data and the survey data;
a data analytics tool that mines the telemetry data for the data patterns associated with any of known attributes and anomaly attributes of the electronic device,
wherein the telemetry data comprises an identification code, and wherein the instructions executable by the processor links the survey data with the telemetry data based on the identification code.

12. The computer system claim 11, comprising a survey generator to generate a second survey for user feedback based on any of the telemetry data and the data patterns.

13. The computer system claim 11, wherein the data analytics tool is set to compare the telemetry data and the survey data across multiple electronic devices and from multiple user feedback.

14. A non-transitory computer readable medium comprising code set to:
analyze telemetry data related to an electronic device;
analyze survey data provided in a first survey comprising user feedback pertaining to the electronic device;
identify similar data patterns in the telemetry data and the survey data;
correlate the survey data with the telemetry data based on the similar data patterns; and
generate a second survey for user feedback based on any of the telemetry data, data patterns in the telemetry data, and data patterns in the survey data.

15. The non-transitory computer readable medium of claim 14, wherein the code is set to compare the telemetry data and the survey data across multiple electronic devices and from multiple user feedback.
